(19) United States
(12) Patent Application Publication
(10) Pub. No.: US 2022/0308231 A1
(43) Pub. Date: Sep. 29, 2022

(54) METHOD FOR RANGE DETERMINATION FOR A LIDAR SENSOR

(71) Applicant: Robert Bosch GmbH, Stuttgart (DE)

(72) Inventors: Gabriela Samagaio, Maia (PT); Carl Mueller-Roemer, Stuttgart (DE); Farooq Ahmed Zuberi, Moeglingen (DE); Joao Andrade, Porto (PT); Juan Carlos Garza Fernandez, Stuttgart (DE); Sebastien Lemetter, Leonberg (DE); Chengxuan Fu, Ditzingen (DE); Nikolaus Moehler, Boeblingen (DE); Ricardo Martins Costa, Esposende (PT)

(21) Appl. No.: 17/695,198

(22) Filed: Mar. 15, 2022

(30) Foreign Application Priority Data
Mar. 24, 2021 (DE) 10 2021 202 878.0

(51) Int. Cl. G01S 17/894

(52) U.S. Cl. CPC G01S 17/894

(57) ABSTRACT

A method for range determination for a LIDAR sensor. The method includes: receiving measured values of a LIDAR sensor organized in a point cloud, and each including pieces of directional information and radial distance information relative to the LIDAR sensor and representing a laser beam reflected from the particular direction and at the particular radial distance; assigning the measured values based on the pieces of directional and radial distance information to areas of interest of a field of view; ascertaining a maximum distance range as an area of interest including a maximum radial distance to the LIDAR sensor and a point distribution of measured values of the area of interest, which includes a variance which reaches or exceeds a predetermined limiting value; and providing a value of the radial distance of the maximum distance range to the LIDAR sensor as the maximum range of the LIDAR sensor.

### FIELD

The present invention relates to a method for range determination for a LIDAR sensor.

### BACKGROUND INFORMATION

LIDAR sensors are an important component in the fields of driver assistance and autonomous driving of vehicles, in that LIDAR sensors may provide precise pieces of distance information of objects in the viewing range of the vehicle. The maximum range of a LIDAR sensor represents a maximum distance to the LIDAR sensor within which object recognition by the LIDAR sensor is possible. The range of the LIDAR sensor is dependent for this purpose on multiple factors, for example, the reflectivity of the objects, visibility conditions due to weather conditions (for example, precipitation, fog, snow), or soiling of the sensor. For reliable driver assistance and for safe autonomous driving, the driver assistance system or the autonomous controller has to be able to react appropriately to such impairments, for example, by reducing speed. It is therefore important that assistance systems or controllers of vehicles have pieces of information with respect to the maximum range of LIDAR sensors to be able to judge the reliability of the measured data of the LIDAR sensors.

### SUMMARY

It is an object of the present invention to provide an improved method for range determination for a LIDAR sensor.

This object may be achieved by a method for range determination for a LIDAR sensor in accordance with the present invention. Advantageous embodiments of the present invention are disclosed herein.

According to one aspect of the present invention, a method for range determination for a LIDAR sensor is provided. In accordance with an example embodiment of the present invention, the method includes:

receiving measured values of a LIDAR sensor, the measured values being organized in a point cloud, and each measured value includes a piece of directional information and a piece of radial distance information relative to the LIDAR sensor and represents a laser beam reflected from the particular direction and at the particular radial distance;

assigning the measured values of the point cloud, based on the pieces of directional information and the pieces of radial distance information, to areas of interest of the one field of view of the LIDAR sensor, each area of interest being defined by a directional range and a radial distance range;

ascertaining a maximum distance range as an area of interest having a maximum radial distance to the LIDAR sensor and a point distribution of measured values of the area of interest which includes a variance which reaches or exceeds a predetermined limiting value; and

providing a value of the radial distance of the maximum distance range to the LIDAR sensor as the maximum range of the LIDAR sensor.

In this way, the technical advantage may be achieved that an improved method for range determination for a LIDAR sensor may be provided. For this purpose, maximum distance ranges to the LIDAR sensor are ascertained based on a point cloud of measured values of a LIDAR sensor and their radial distance to the LIDAR sensor is interpreted as the maximum range of the LIDAR sensor. The maximum distance ranges are distinguished for this purpose in relation to other areas of interest of the field of view of the LIDAR sensor by a maximum radial distance to the LIDAR sensor and by a point distribution of the measured values within the maximum distance ranges, whose variance reaches or exceeds a predetermined limiting value. A method for range determination for a LIDAR sensor which is simple to carry out may be provided by the determination of the variance of the point distributions of the individual areas of interest of the LIDAR sensor and the maximum distance ranges thus ascertained.

According to one specific example embodiment of the present invention, an object situated in the particular area of interest of the LIDAR sensor is represented by measured values of a point distribution assigned to an area of interest including a variance greater than or equal to the predetermined limiting value.

In this way the technical advantage may be achieved that the range determination of the LIDAR sensor is carried out based on the objects situated in the field of view of the LIDAR sensor. In that the limiting value for the variance is selected in accordance with a mean variance which represents an existing object, the range determination of the LIDAR sensor may be linked to the detection of objects. Due to the corresponding selection of the limiting value of the variance, areas of interest in which objects are situated will on average have point distributions including variances greater than or equal to the predetermined limiting value. Upon detection of an object, the particular area of interest in which the object is situated may be identified as a maximum distance range if it has a maximum radial distance, and the range determination of the LIDAR sensor may therefore take place based on the detection of the object. In addition, the maximum range may be determined via the radial distance of the maximum distance range and may thus be associated with the distance of the detected object. The maximum range of the LIDAR sensor may thus be specified using the maximum radial distance of an actually detected object.

According to one specific example embodiment of the present invention, the assignment of the measured values of the point cloud in areas of interest includes:

assigning the measured values of the point cloud to directional ranges; and

assigning the measured values of the directional ranges to radial distance ranges.

In this way, the technical advantage may be achieved that a precise assignment of the measured values of the point cloud to individual areas of interest of the field of view of the LIDAR sensor may be achieved.

According to one specific example embodiment of the present invention, the ascertainment of the maximum distance range furthermore includes:

Determining variances of point distributions of areas of interest of a directional range in a sequence including a descending radial distance of the areas of interest to the LIDAR sensors; the maximum distance range of the particular directional range being given by the first area of interest in the sequence including a descending radial distance which includes a point distribution having a variance which reaches or exceeds the predetermined limiting value.

In this way, the technical advantage may be achieved that a simple and rapid method for ascertaining a maximum distance range is enabled. For this purpose, for the individual directional ranges, starting from the areas of interest including a greater radial distance to the LIDAR sensor, which are thus situated in the outside area of the field of view of the LIDAR sensor, in a sequence including a descending radial distance and thus in the direction toward the LIDAR sensor, variances of the point distributions of the measured values of the individual areas of interest are determined. The first area of interest which, in the particular sequence including a descending radial distance, in which areas of interest are studied in succession in the direction of the LIDAR sensor with respect to the variance of the particular point distribution, includes a point distribution including a variance greater than or equal to the predetermined limiting value, is identified for this purpose as the maximum distance range for the particular directional range.

According to one specific example embodiment of the present invention, a maximum distance range and a corresponding maximum range are provided for each directional range.

In this way, the technical advantage may be achieved that a comprehensive determination of the maximum range of the LIDAR sensor may be provided for the entire field of view of the LIDAR sensor and, linked thereto, for various directional ranges of the LIDAR sensor. The maximum range of the LIDAR sensor may thus be ascertained for various directional ranges of the field of view of the LIDAR sensor. Alternatively, the maximum range of the LIDAR sensor may be defined as the greatest radial distance of the various maximum distance ranges of the individual directional ranges.

According to one specific example embodiment of the present invention, the variance includes a radial variance along a radial direction and/or a concentric variance along a concentric direction oriented perpendicularly to the radial direction.

In this way, the technical advantage may be achieved that a precise ascertainment of the variance of the point distribution of the measured values of the individual areas of interest of the field of view of the LIDAR sensor is enabled. The variance of the point distribution may be determined for this purpose in the radial direction or in the concentric direction to the LIDAR sensor. In this way, various point distributions may be taken into consideration and informative variances may be ascertained for any arbitrary point distributions.

According to one specific example embodiment of the present invention, the predetermined limiting value of the variance is determined by an artificial intelligence, the artificial intelligence being trained on a relationship between objects present in areas of interest and variances of point distributions of measured values of the particular areas of interest.

The technical advantage may be achieved in this way that a precise ascertainment of the predetermined limiting value of the variance is enabled. The artificial neural network may learn in this case, based on corresponding training data sets, a relationship between the variance of a point distribution and a corresponding detected object and ascertain based thereon a limiting value of the variance, which is reached or exceeded on average by the particular associated point distribution of measured values if an object is present.

According to one specific example embodiment of the present invention, the predetermined limiting value of the variance is experimentally ascertained.

In this way, the technical advantage may be achieved that a precise limiting value may be ascertained for the variance. The experimenter may thus, for differently formed and differently oriented objects, determine the variances of the corresponding point distributions of the measured values of the LIDAR sensor within the areas of interest in which the objects are situated, to thus ascertain as a limiting value a minimum variance which the particular point distribution includes on average if an object is present.

According to one specific example embodiment of the present invention, the predetermined limiting value of the variance is dependent on the radial distance, different predetermined limiting values being determined for areas of interest including a different radial distance.

The technical advantage may be achieved in this way that a precise determination of the limiting value of the variance and, linked thereto, a precise ascertainment of the range of the LIDAR sensor is enabled. Due to the consideration of the radial distance for the determination of the limiting values of the variance, for very remote objects, which naturally results in less densely distributed point sets within the particular areas of interest and, linked thereto, lower values of the variance of the point distributions, an ascertainment of the particular object based on the particular variance of the point distribution may also be achieved precisely. This enables a precise ascertainment of the maximum distance range, in particular for very remote objects.

According to one specific example embodiment of the present invention, providing the maximum range includes: Ascertaining a mean radial distance of the point distribution of the measured values of the maximum distance range as the radial distance of the maximum distance range.

The technical advantage may be achieved in this way that a precise maximum range of the LIDAR sensor may be ascertained. For this purpose, the radial distance of the range including maximum radial distance, which is interpreted as the maximum range of the LIDAR sensor, is ascertained by the average radial distance of the point distribution of the measured values of the particular area of interest. Due to the very unevenly distributed measured values of the point distribution, which are situated largely in the area of the positioning of the object due to the presence of the object, the average radial distance of the measured values of the particular area of interest corresponds to the radial distance of the object to the LIDAR sensor. The maximum range of the LIDAR sensor thus corresponds to the radial distance of the particular object situated in the directional range of the field of view of the LIDAR sensor.

According to one specific example embodiment of the present invention, the method for range determination of the LIDAR sensor is carried out during a time-of-flight of the LIDAR sensor.

The technical advantage may be achieved in this way that a determination of the range of the LIDAR sensor during the operation of the LIDAR sensor is enabled. In this way, the particular range may be determined at any time during the operation of the LIDAR sensor for various spatial directions of the LIDAR sensor. The ascertained range may be taken into consideration in this case in the judgment of the reliability of the measured values of the LIDAR sensor.

According to a second aspect of the present invention, a processing unit is provided, the processing unit being configured to carry out the method according to the present invention for range determination of a LIDAR sensor according to one of the preceding specific example embodiments.

According to a third aspect of the present invention, a computer program product including commands is provided which, upon execution of the program by a data processing unit, prompt it to carry out the method according to the present invention for range determination of a LIDAR sensor according to one of the preceding specific example embodiments.

Exemplary embodiments of the present invention are explained on the basis of the figures.

### BRIEF DESCRIPTION OF THE DRAWINGS

FIG. 1 shows a schematic representation of a LIDAR sensor and a field of view of the LIDAR sensor according to one specific example embodiment of the present invention.

FIG. 2 shows a schematic representation of the LIDAR sensor and the field of view in FIG. 1 including a point cloud of measured values of the LIDAR sensor according to one specific example embodiment of the present invention.

FIG. 3 shows a diagram of a radial profile of two point distributions of two different areas of interest.

FIG. 4 shows a flowchart of a method for range determination for a LIDAR sensor according to one specific example embodiment of the present invention.

FIG. 5 shows a schematic representation of a computer program product.

### DETAILED DESCRIPTION OF EXAMPLE EMBODIMENTS

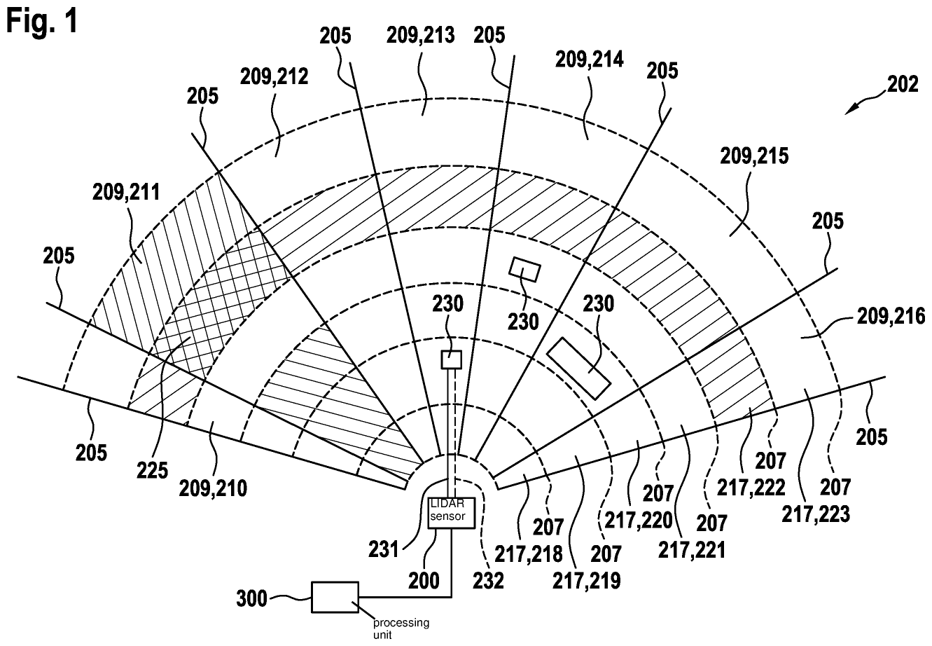

FIG. 1 shows a schematic representation of a LIDAR sensor 200 and a field of view 202 of LIDAR sensor 200 according to one specific embodiment.

Field of view 202 includes a plurality of field of view directions 205 and radial distances 207. Field of view directions 205 define differently oriented directional ranges 209. In the specific embodiment shown, field of view 202 includes a first directional range 210, a second directional range 211, a third directional range 212, a fourth directional range 213, a fifth directional range 214, a sixth directional range 215, and a seventh directional range 216. Different radial distances 207 each describe different radial distances to LIDAR sensor 200 and define different radial distance ranges 217. Field of view 202 shown includes a first radial distance range 218, a second radial distance range 219, a third radial distance range 220, a fourth radial distance range 221, a fifth radial distance range 222, and a sixth radial distance range 223 in this case. Directional ranges 209 and radial distance ranges 217, which overlap one another, each define a plurality of areas of interest 225. In the specific embodiment shown, this is shown for the overlap between second directional range 211 and fifth radial distance range 222.

Furthermore, a plurality of objects 230 are shown in FIG. 1, which are situated in different areas of interest 225 of field of view 202 in relation to LIDAR sensor 200. According to the normal functionality of a LIDAR sensor, objects 230 are detected by LIDAR sensor 200 by emitting laser beams 231 and receiving laser beams 232 reflected on particular objects 230.

The specific embodiment of field of view 202 shown in FIG. 1, in particular the number and size of directional ranges 209, radial distance ranges 217, and areas of interest 225 resulting therefrom is solely by way of example and in reality may be designed variably and differing from the specific embodiment shown here.

FIG. 1 furthermore shows a processing unit 300, which is connected to LIDAR sensor 200 and is configured to carry out the method according to the present invention for range determination of a LIDAR sensor 200.

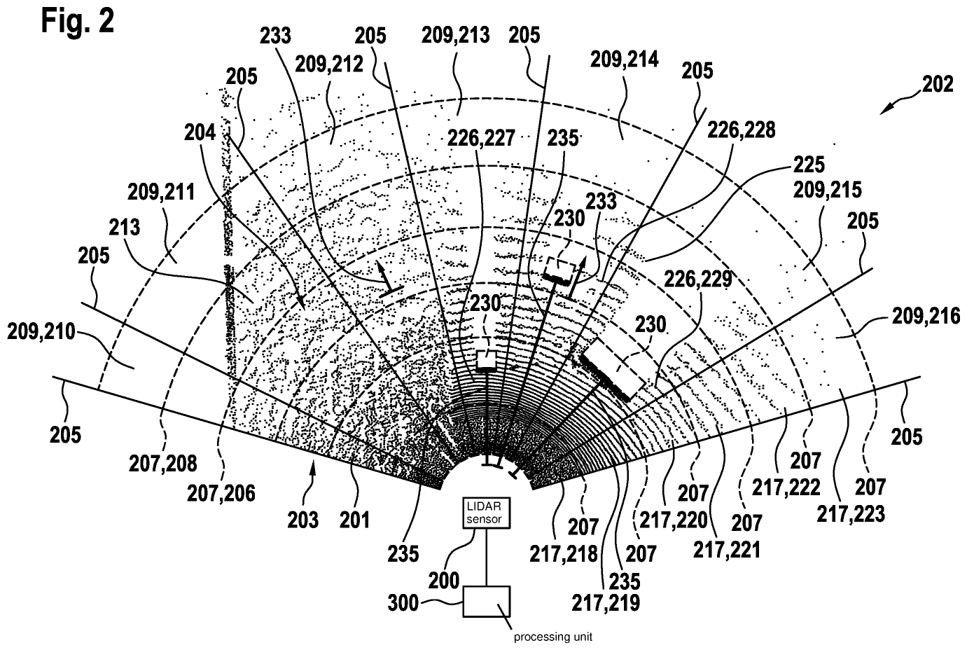

FIG. 2 shows a schematic view of LIDAR sensor 200 and field of view 202 from FIG. 1 including a point cloud 203 of measured values 201 of LIDAR sensor 200 according to one specific embodiment.

Point cloud 203 shown in FIG. 2 is solely by way of example and is not to represent a real recorded point cloud of a LIDAR sensor. Point cloud 203 includes various point distributions 204 in various areas of interest 225 of field of view 202 of LIDAR sensor 200. Various point distributions 204 include measured values 201 of LIDAR sensor 200 here, which are situated in differing density in particular point distributions 204. Measured values 201 of particular point distribution 204 situated in an area of interest 225 correspond here to laser beams 232 received by LIDAR sensor 200 and reflected from particular areas of interest 225 of field of view 202. Measured values 201 may be based here on actual signals of reflected laser beams or may result from noise of LIDAR sensor 200.

Furthermore, objects 230 of FIG. 1 are shown in FIG. 2. Objects 230 are reflected in point cloud 203 of measured values 201 due to a concentration of measured values 201 of point distributions 204 of particular areas of interest 225. Point distributions 204 within particular areas of interest 225 of objects 230 include an increased concentration of measured values 201 here at the particular surfaces of objects 230 oriented toward LIDAR sensor 200 and a density reduced to nearly zero in the radial direction in the shaded area of particular object 230. This results because particular laser beams 231 of LIDAR sensor 200 are exclusively reflected on the surfaces of object 230 oriented toward LIDAR sensor 200. Point distributions 204 of areas of interest 225 in which objects 230 are situated are thus substantially different from point distributions 204 of measured values 201 of other areas of interest 225 of field of view 202 and are significantly more uneven in the distribution of measured values 201, while areas of interest 225 without objects 230 include nearly equally distributed point distributions. In particular, point distributions 204 of areas of interest 225 in which objects 230 are situated have a substantially increased variance in relation to point distributions 204 of areas of interest 225 in which no objects 230 are situated and which on average have a uniform distribution of measured values 201.

To determine the maximum range of LIDAR sensor 200 according to the method according to the present invention for range determination of a LIDAR sensor, for different areas of interest 225, variances of point distributions 204 of measured values 201 of particular areas of interest 225 are ascertained. To ascertain the variances of the point distributions, conventional methods for variance determination of point distributions may be used here. The variance may be determined here as a deviation of a number of measured values within a spatial area from an expected mean value of the number of measured values for the particular spatial area. For example, the variance may be expressed according to the following relationship:

VAR(X):=E((X−μ)²)=∫_{Ω}(X−μ)²dP with E(X)=μ the experiential value of random variable X and Ω, P variables of a random space.

To ascertain the range of LIDAR sensor 200, to determine the variances of point distributions 204 of individual areas of interest 225, starting from areas of interest 225 farthest away in the radial direction from LIDAR sensor 200, which are defined in the specific embodiment shown by sixth radial distance range 223, areas of interest 225 may be studied with respect to the variance of particular point distributions 204 in succession in a sequence with descending radial distance 207 and thus in the direction of LIDAR sensor 200. Area of interest 225 situated farthest away in the radial direction from LIDAR sensor 200, whose point distribution 204 includes a variance which reaches or exceeds a predetermined limiting value, is defined here as a maximum distance range 226. To ascertain maximum range 235 of LIDAR sensor 200, the radial distance of particular maximum distance range 226 is defined here. To determine the radial distance of particular maximum distance range 226, a mean radial distance 236 of measured values 201 of particular point distribution 204 may be ascertained.

According to one specific embodiment, a corresponding maximum distance range 226 may be ascertained for a plurality or each of different directional ranges 209 of field of view 202. For this purpose, the described method may be carried out for each of directional ranges 209 of field of view 202, in that for particular directional range 209, starting from area of interest 225 situated farthest away in the radial direction from LIDAR sensor 200, individual areas of interest 225 of particular directional range 209 may be studied with respect to the variance of particular point distributions 204 in succession in a sequence including a descending radial distance and thus in the direction of LIDAR sensor 200.

In the specific embodiment shown, corresponding maximum distance ranges 226 are ascertained on the basis of the example of the three objects 230 situated in different directional ranges 209. For fourth directional range 213, the area of interest, in which object 230 is situated and which is defined by fourth directional range 213 and second radial distance range 219, thus corresponds to a first maximum distance range 227. Due to object 230 situated in this area and the concentration of measured values 201 of point distribution 204 based thereon, point distribution 204 of the mentioned area of interest includes a variance which reaches or exceeds the particular predetermined limiting value. The areas of interest of fourth directional range 213 farther away in the radial direction each have point distributions 204 including a lesser variance, so that for particular fourth directional range 213, mentioned first maximum distance range 227 includes the greatest radial distance to LIDAR sensor 200 of the areas of interest of fourth directional range 213, which include a variance of the measured values greater than or equal to the limiting value. To determine the radial distance of first maximum distance range 227, furthermore a mean radial distance 236 of point distribution 204 of first maximum distance range 227 is ascertained. As shown in FIG. 2, mean radial distance 236 corresponds to the concentration of measured values 201 within point distribution 204, which corresponds to the position of particular object 230.

Similarly to described first maximum distance range 227, both fifth directional range 214 and also sixth directional range 215 include corresponding second and third maximum distance ranges 228, 229. Second and third maximum distance ranges 228, 229 each correspond to the areas of interest in which objects 230 shown are situated. To ascertain second and third maximum distance ranges 228, 229, similarly to the description above, the individual areas of interest may be studied with respect to the variance of point distribution 204, starting from the particular areas of interest of the particular directional range situated farthest from LIDAR sensor 200, in succession with a descending radial distance and in the direction of LIDAR sensor 200. Due to the concentration of point distributions 204 of measured values 201 within the areas of interest in which objects 230 are situated, these areas of interest include a variance above the predetermined limiting value, while the further areas of interest farther away from LIDAR sensor 200 consistently include uniformly distributed point distribution of lower variance, so that the particular areas of interest including the objects are identified as corresponding maximum distance ranges 226.

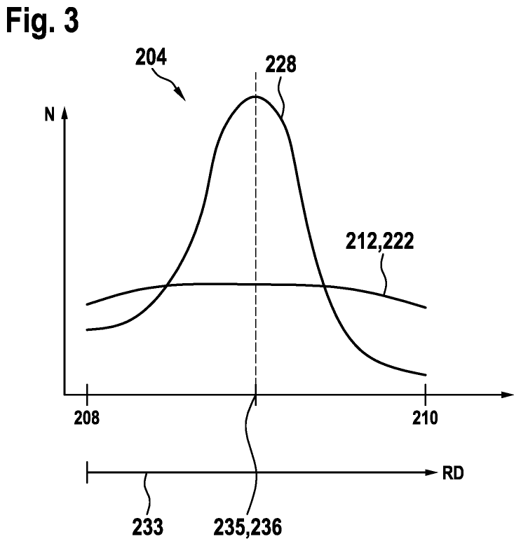

To illustrate the variance of point distribution 204 of various areas of interest 225, particular point distributions 204 of measured values 201 in radial direction 233 are shown in FIG. 3 for second maximum distance range 228 and the area of interest which is defined by third directional range 212 and fourth radial distance range 221.

FIG. 3 shows a diagram of a radial profile of two point distributions 204 of two different areas of interest 225.

FIG. 3 shows the number of measured values 201 in relation to radial distance RD of point distributions 204 of second maximum distance range 228 and of area of interest 225 defined by third directional range 212 and fourth radial distance range 221 in radial direction 233 in relation to LIDAR sensor 200. Point distribution 204 of second maximum distance range 228 has a substantial increase at the level of mean radial distance 236. This is because of the presence of object 230 and the correspondingly strengthened reflection of the laser beams of LIDAR sensor 200 on the surfaces of object 230 facing toward the LIDAR sensor. Point distribution 204 of area of interest 225 defined by third directional range 212 and fourth radial distance range 221, in contrast, has a constant profile in radial direction 233. The variances of the two point distributions 204 are substantially different here, point distribution 204 of second maximum distance range 228 including an increased variance due to the uneven distribution of measured values 201.

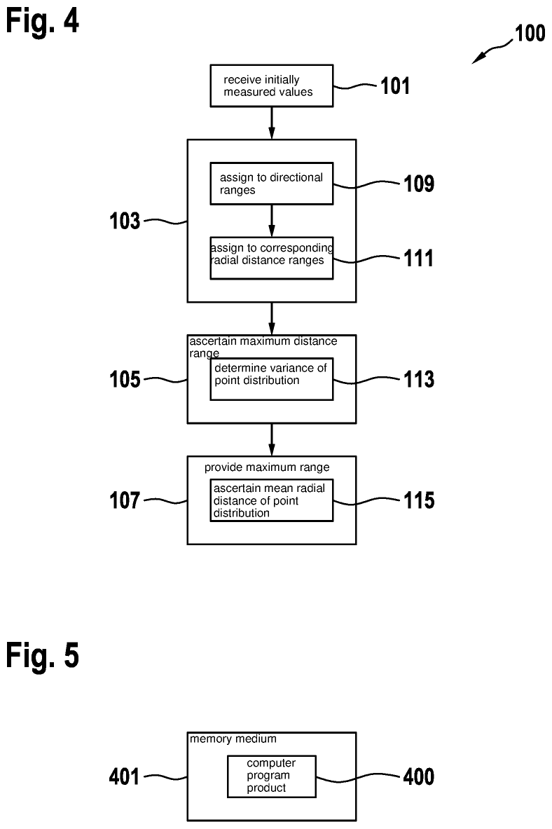

FIG. 4 shows a flowchart of a method 100 for range determination for a LIDAR sensor 200 according to one specific embodiment.

Method 100 according to the present invention for range determination of a LIDAR sensor 200 is applicable to a LIDAR sensor 200 according to FIGS. 1 and 2.

In a first method step 101, initially measured values 201 of LIDAR sensor 200 are received.

In a further method step 103, measured values 201 situated in a point cloud 203 are assigned to various areas of interest 225 of a field of view 202 of LIDAR sensor 200.

For this purpose, initially in a method step 109, measured values 201 are assigned to various directional ranges 209 of field of view 202.

In a method step 111, measured values 201 assigned to directional ranges 209 are assigned to corresponding radial distance ranges 217. The assignment described here of measured values 201 of point cloud 203 of LIDAR sensor 200 to particular areas of interest 225 of field of view 202 of LIDAR sensor 200 corresponds to the assignment shown in FIG. 2. The assignment is based here on the consideration of particular directional or radial distance information of individual measured values 201.

In a following method step 105, a maximum distance range 226 is ascertained, maximum distance range 226 being distinguished by a maximum radial distance to LIDAR sensor 200 and by a point distribution 204 of measured values 201 assigned to the particular area of interest which includes a variance which reaches or exceeds a predetermined limiting value.

To ascertain maximum distance range 226, in a method step 113, for various areas of interest 225 of a directional range 209, a variance of particular point distribution 204 of particular area of interest 225 is determined. For this purpose, starting from an area of interest 225 situated farthest away in the radial direction from LIDAR sensor 200, the variance of point distributions 204 of individual areas of interest 225 is determined in succession in a sequence including a descending radial distance and thus in the direction of LIDAR sensor 200. First area of interest 225, which has a point distribution 204 including a variance greater than or equal to the predetermined limiting value in the mentioned sequence including a descending radial distance, is identified here as maximum distance range 226 of particular directional range 209. The mentioned procedure may be performed here for all directional ranges 209 of field of view 202 of LIDAR sensor 200, so that a maximum distance range 226 is ascertained individually for each directional range 209.

In a following method step 107, a maximum range 235 is provided, maximum range 235 corresponding to a radial distance of particular maximum distance range 226 identified for directional range 209.

To determine maximum range 235, in a further method step 115, a mean radial distance 236 of point distribution 204 of measured values 201 of maximum distance range 226 ascertained for particular directional range 209 is determined.

The variance may be formed here as a radial variance in the radial direction or as a concentric variance in a concentric direction situated perpendicularly to the radial direction. The variance may in particular include different values for different radial distances.

According to one specific embodiment, a limiting value of the variance may be ascertained experimentally or by a correspondingly trained neural network.

FIG. 5 shows a schematic view of a computer program product 400, including commands which, upon the execution of the program by a processing unit, prompt it to carry out method 100 for range determination for a LIDAR sensor 200 according to one of the above-mentioned specific embodiments. Computer program product 400 is stored on a memory medium 401 in the specific embodiment shown. Memory medium 401 may be any conventional memory medium.

1-13. (canceled)

14. A method for range determination for a LIDAR sensor, comprising the following steps:
receiving measured values of a LIDAR sensor, the measured values being organized in a point cloud, and each measured value of the measured values including a piece of directional information and a piece of radial distance information relative to the LIDAR sensor and representing a laser beam reflected from a particular direction and at a particular radial distance;
assigning the measured values of the point cloud based on the pieces of directional information and the pieces of radial distance information to areas of interest of a field of view of the LIDAR sensor, each of the areas of interest being defined by a directional range and a radial distance range;
ascertaining a maximum distance range as an area of interest of the areas of interest including a maximum radial distance to the LIDAR sensor and a point distribution of measured values of the area of interest, which includes a variance which reaches or exceeds a predetermined limiting value; and
providing a value of the radial distance of the maximum distance range to the LIDAR sensor as the maximum range of the LIDAR sensor.

15. The method as recited in claim 14, wherein an object situated in an area of interest of the LIDAR sensor is represented by measured values of a point distribution assigned to the area of interest including a variance greater than or equal to the predetermined limiting value.

16. The method as recited in claim 14, wherein the assignment of the measured values of the point cloud to areas of interest includes:
assigning the measured values of the point cloud to directional ranges; and
assigning the measured values of the directional ranges to radial distance ranges.

17. The method as recited in claim 16, wherein the ascertainment of the maximum distance range further includes:
determining variances of point distributions of the areas of interest of a directional range in a sequence including a descending radial distance of the areas of interest from the LIDAR sensor, the maximum distance range of a particular directional range being given by a first area of interest in the sequence including a descending radial distance which includes a point distribution including a variance which reaches or exceeds the predetermined limiting value.

18. The method as recited in claim 15, wherein, for each directional range, a maximum distance range and a corresponding maximum range are provided.

19. The method as recited in claim 14, wherein the variance includes a radial variance along a radial direction and/or a concentric variance along a concentric direction oriented perpendicularly to the radial direction.

20. The method as recited in claim 14, wherein the predetermined limiting value of the variance is determined by an artificial intelligence, and the artificial intelligence is trained on a relationship between objects present in the areas of interest and variances of the point distributions of measured values of each of the areas of interest.

21. The method as recited in claim 14, wherein the predetermined limiting value of the variance is experimentally ascertained.

22. The method as recited in claim 14, wherein the predetermined limiting value of the variance is a function of the radial distance, and different predetermined limiting values are determined for the areas of interest of different radial distance.

23. The method as recited in claim 14, wherein the providing of the maximum range includes:
ascertaining a mean radial distance of the point distribution of the measured values of the maximum distance range as the radial distance of the maximum distance range.

24. The method as recited in claim 14, wherein the method for range determination of the LIDAR sensor is carried out during a time-of-flight of the LIDAR sensor.

25. A computing unit configured to determine a range for a LIDAR sensor, the computing unit configured to:
receive measured values of a LIDAR sensor, the measured values being organized in a point cloud, and each measured value of the measured values including a piece of directional information and a piece of radial distance information relative to the LIDAR sensor and representing a laser beam reflected from a particular direction and at a particular radial distance;
assign the measured values of the point cloud based on the pieces of directional information and the pieces of radial distance information to areas of interest of a field of view of the LIDAR sensor, each of the areas of interest being defined by a directional range and a radial distance range;
ascertain a maximum distance range as an area of interest of the areas of interest including a maximum radial distance to the LIDAR sensor and a point distribution of measured values of the area of interest, which includes a variance which reaches or exceeds a predetermined limiting value; and
provide a value of the radial distance of the maximum distance range to the LIDAR sensor as the maximum range of the LIDAR sensor.

26. A non-transitory computer-readable medium on which is stored a computer program including commands for range determination for a LIDAR sensor, the computer program, when executed by a data processing unit, causing the data processing unit to perform the following steps:
receiving measured values of a LIDAR sensor, the measured values being organized in a point cloud, and each measured value of the measured values including a piece of directional information and a piece of radial distance information relative to the LIDAR sensor and representing a laser beam reflected from a particular direction and at a particular radial distance;
assigning the measured values of the point cloud based on the pieces of directional information and the pieces of radial distance information to areas of interest of a field of view of the LIDAR sensor, each of the areas of interest being defined by a directional range and a radial distance range;
ascertaining a maximum distance range as an area of interest of the areas of interest including a maximum radial distance to the LIDAR sensor and a point distribution of measured values of the area of interest, which includes a variance which reaches or exceeds a predetermined limiting value; and
providing a value of the radial distance of the maximum distance range to the LIDAR sensor as the maximum range of the LIDAR sensor.
